(19) United States
(12) Patent Application Publication
(10) Pub. No.: US 2008/0124122 A1
(43) Pub. Date: May 29, 2008

(54) Resiliently Biased Developing Cartridge

(76) Inventor: Pater Zhang, Shen Zhen City (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,970

(22) PCT Filed: Jan. 25, 2006
(86) PCT No.: PCT/AU06/00081

§ 371 Date: Jul. 25, 2007

(30) Foreign Application Priority Data
Jan. 25, 2005 (AU) 2005900310

(51) Int. Cl. G03G 21/16

(52) U.S. Cl. 399/126

(57) ABSTRACT

A resiliently biased developing cartridge 12 adapted to be received within a drum cartridge 10 having a photosensitive drum 16 and a rear wall 54, the resiliently biased developing cartridge 12 having at least one resilient means 22 and a developer roller 20, such that, when the developing cartridge 12 is received within the drum cartridge 10, the compression of the at least one resilient means 22 against the rear wall 54 of the drum cartridge 10 results in the positioning of the developing cartridge 12 such that a predetermined pressure is applied by the developer roller 20 against the photosensitive drum 16.

### FIELD OF THE INVENTION

The invention relates to a resiliently biased developing cartridge.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

As will be known to the person skilled in the art, there are two families of methods by which a latent image can be developed. The first family of methods involves bringing a developer roller, housed in a developing cartridge, into close proximity with an image bearing member, housed in a drum cartridge. Electrostatic attraction or magnetism, or other like forces, can then be used to cause toner to jump from the developer roller to the image bearing member.

In the second family of methods, the developer roller contacts the image bearing member. Friction, sometimes supplemented with electrostatic or magnetic attraction, is then used to transfer toner from the developer roller to the image bearing member.

Irrespective of the family of methods used, the relative position of the developer roller to the image bearing member is critical.

Traditionally, this critical relationship has seen the developing cartridge translationally fixed with respect to the drum cartridge. This requires both the developing cartridge frame and drum cartridge frame to be accurately constructed. A complicated locking mechanism is then commonly used to draw the developing cartridge and the drum cartridge together in such a manner that the required spacing and pressing force, if any, is achieved.

The problem with such locking mechanisms is that they increase the production cost of the resulting process cartridge while also making the resulting process cartridge more susceptible to breakage. Further, as the surface of the image bearing member and developer roller abrade and wear over time, the spacing between these fixed components change. This can then produce print quality problems.

It is therefore an object of the present invention to provide a resiliently biased developing cartridge that overcomes, or at least reduces the effects of, one or more of the above mentioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is a resiliently biased developing cartridge adapted to be received within a drum cartridge having a photosensitive drum and a rear wall, the resiliently biased developing cartridge having at least one resilient means and a developer roller, such that, when the developing cartridge is received within the drum cartridge, the compression of the at least one resilient means against the rear wall of the drum cartridge results in the positioning of the developing cartridge such that a predetermined pressure is applied by the developer roller against the photosensitive drum.

The at least one resilient means take the form of a torsion coil spring.

Ideally, the developing cartridge has a recess for each resilient means, each resilient means able to retract into the recess to facilitate the receipt of the developing cartridge within the drum cartridge. The resilient means may have a curved portion that guides the resilient means to the retracted position as the developing cartridge is received within the drum cartridge. In its preferred form, the resilient means is biased towards its non-retracted position.

The resilient means may remain retracted in the recess until an actuating projection provided in the drum cartridge makes contact with a predetermined portion of the developing cartridge.

Preferably, the resiliently biased developing cartridge also including a locking mechanism for securely retaining the developing cartridge to the drum cartridge when the developing cartridge is received in the drum cartridge.

The pressure applied by the resilient means against the rear wall may be in the order of 7 N. The pressure applied by the developer roller against the photosensitive drum may be between 10 N and 20 N.

### BRIEF DESCRIPTION OF THE DRAWINGS

The invention will now be described, by way of example only, with reference to the accompanying drawings, in which:

FIG. 1 is an isometric view of a drum cartridge adapted to receive a developing cartridge of the present invention.

FIG. 2 is a cross-sectional view of a developing cartridge of the present invention mated with the drum cartridge shown in FIG. 1.

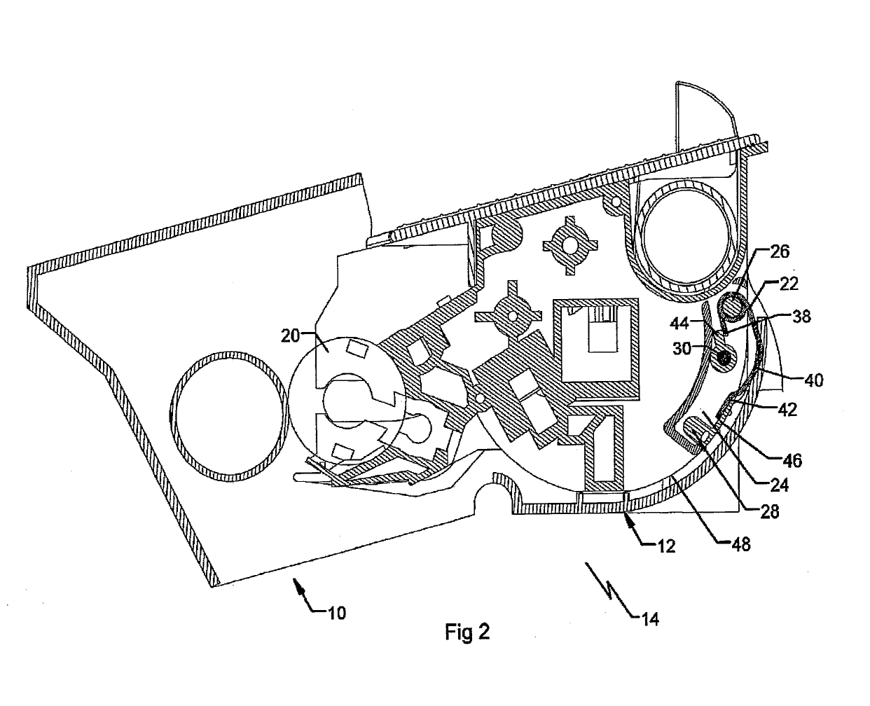

FIGS. 3a, 3b and 3c are plan and isometric views of a spring clip that forms part of the present invention.

FIG. 4 is an isometric view of the developing cartridge shown in FIG. 2.

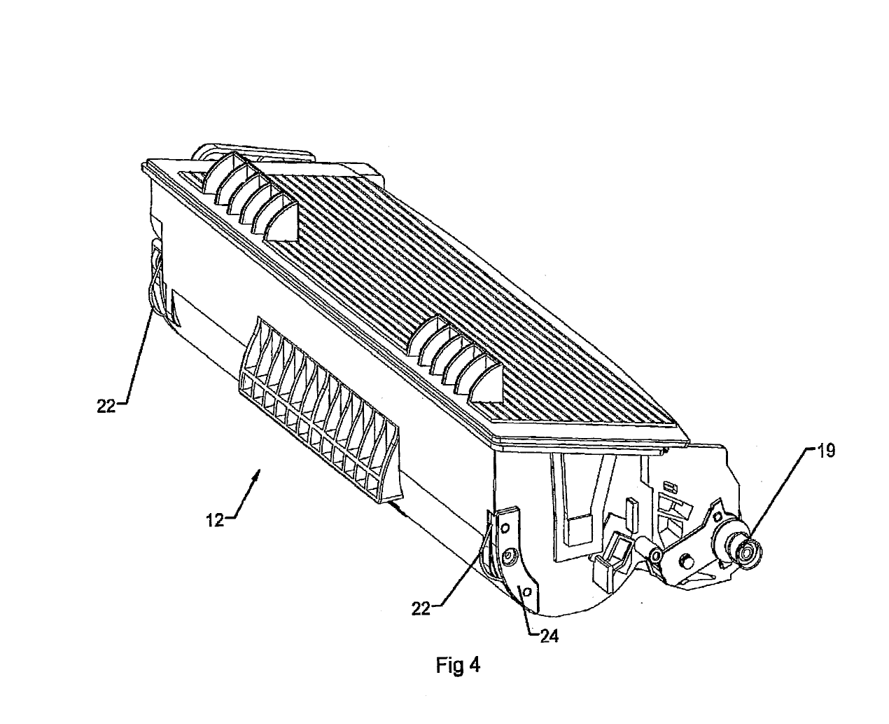

FIG. 5 is an isometric view of the developing cartridge of the present invention mated with the drum cartridge shown in FIG. 1.

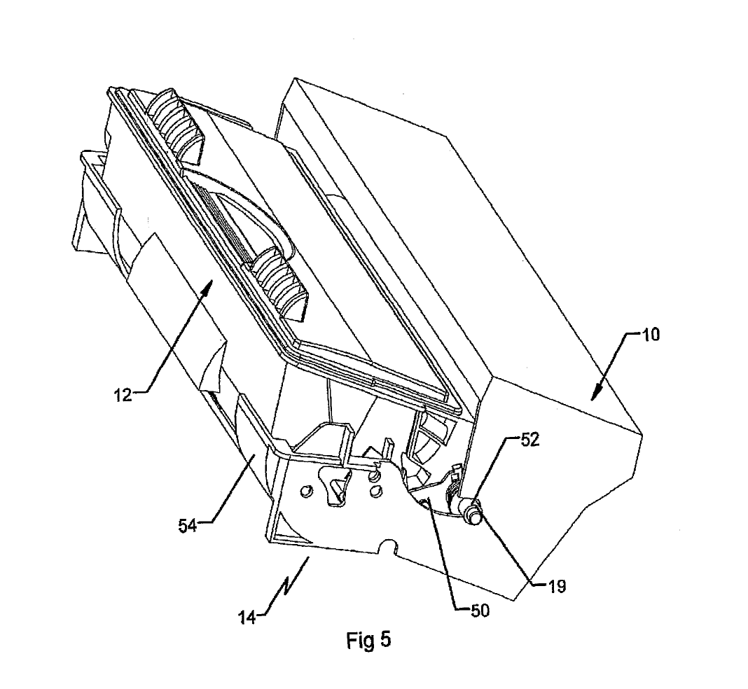

### PREFERRED EMBODIMENTS OF THE INVENTION

In accordance with the preferred embodiment of the invention there is a drum cartridge 10 adapted to mate with a developing cartridge 12. A drum cartridge 10 mated with a developing cartridge 12 will be described hereafter as a process cartridge 14.

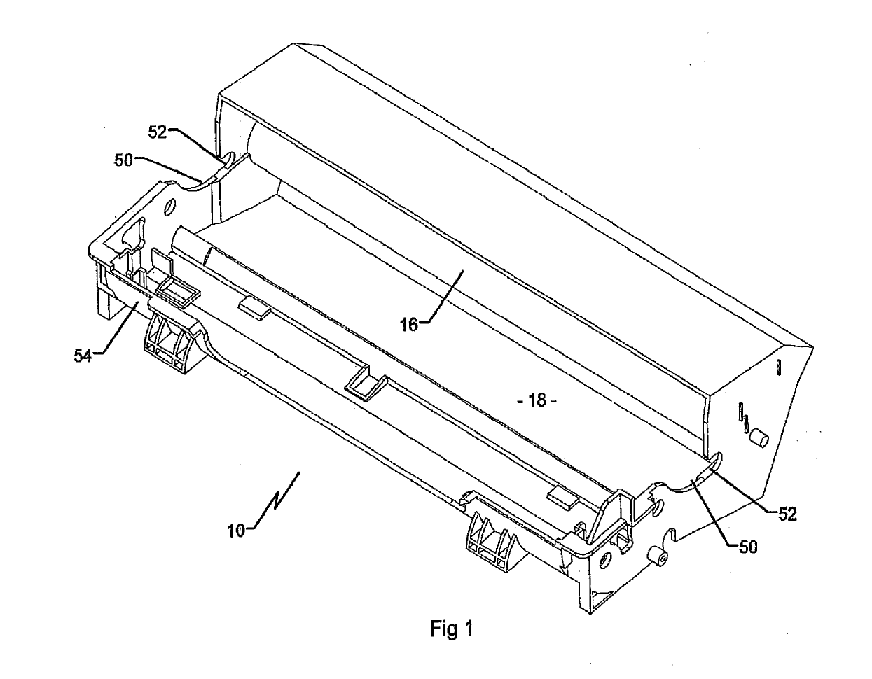

As shown in FIG. 1, the drum cartridge 10 houses a photosensitive drum 16. The photosensitive drum 16 is free to rotate within the drum cartridge 10.

The drum cartridge 10 also has an open base 18. The open base 18 is adapted to receive the developing cartridge 12. The mechanics by which the developing cartridge 12 is received and retained within the open base 18 of the drum cartridge 10 will be explained in more detail below.

The developing cartridge 12 houses a developer roller 20. The developer roller 20 is free to rotate within the developing cartridge 12. The ends 19 of the developer roller 20 extend beyond the casing of the developing cartridge 12.

At the sides of the developing cartridge 12 adjacent the developer roller 20, are mounted two urging springs 22 in the form of torsion coil springs. Each urging spring 22 is contained within its own cover housing 24. The cover housings 24 are identical in construction. Each cover housing 24 is substantially arc-shaped.

Integrally formed with the developing cartridge 12 are two mounting pins 26, 28 and a screw recess 30. The mounting pins 26, 28 are adapted to be received within the cover housings 24 and thereby guide the cover housing 24 to its correct position. Once received in its correct position, the cover housing 24 is securely affixed to the developing cartridge 12′ by way of a screw (not shown) threaded into the screw recess 30.

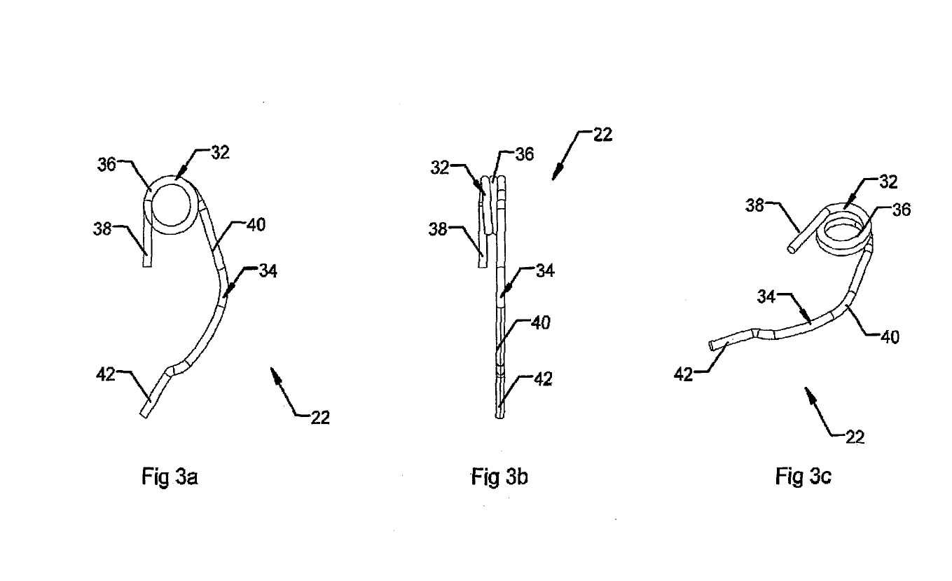

FIGS. 3a, 3b and 3c show the urging springs 22. Each urging spring 22 comprises a coil section 32 and a curved section 34.

The coil section 32 comprises a series of three circular coils 36 leading into an extending arm 38. The curved section 34 comprises a bent portion 40 leading to a retaining arm 42. The end of the bent portion 40 not leading to the retaining arm 42 is integrally connected to the coil section 32 by way of one of the circular coils 36.

The configuration of the urging springs 22 is such that it can engage with the two mounting pins 26, 28 and the screw recess 30. To elaborate:
the three circular coils 36 encircle mounting pin 26;
extending arm 38 abuts a protrusion 44 extending from the screw recess 30 substantially in the direction of mounting pin 26; and
retaining arm 42 abuts a flange 46 that extends away from mounting pin 28 while following the edge 48 of the developing cartridge 12.

In this manner, the bent portion 40 protrudes past the edge 48 of the developing cartridge 12 in a direction away from the orientation of the developer roller 20.

The invention will now be described in the context of its intended interaction with drum cartridge 10.

As mentioned above drum cartridge 10 has an open base 18 for receiving a developing cartridge 12. This reception is facilitated by inserting the ends 19 of the developer roller 20 into channels 50 until such time as they substantially abut channel ends 52.

When the ends 19 substantially abut channel ends 52, the urging springs 22 sit above a rear side 54 of the open base 18. This prevents the developing cartridge 12 from being completely received within the open base 18.

To retain the developing cartridge 12 securely within the open base 18, a user must push down on the exposed top of the developing cartridge 12 near the rear side 54. The developing cartridge 12 then activates a simple locking mechanism (not shown) which securely retains the developing cartridge 12 within the open base 18.

As the user pushes down on the exposed top of the developing cartridge 12, the urging springs 22 is caught between the pressure being applied by the user and the fixed position of the rear side 54. However, the parabolic shape of the bent portion 40 allows the urging springs 22 to retract in line with the force applied.

To illustrate this in more detail, as the bent portion 40 moves inwards in line with the force applied, retaining arm 42 is forced away from its position abutting flange 46. The urging spring 22 is kept in place, however, as the extending arm 38 cannot move in the same direction as the retaining arm 42 due to the position of the protrusion 44. This also allows the retaining arm 42 to retract back towards flange 46 and thereby urge the whole developing cartridge 12 towards the photosensitive drum 16.

It should be noted that in the embodiment described the urging springs 22 press against the rear side 54 with a force of approximately 7 N. However, the compression of the urging springs 22 as described above, result in the developer roller 20 pressing against the photosensitive drum 16 with a force between approximately 10 N and 20 N.

In light of the above it is to be noted by the person skilled in the art that the size and compression strength of the urging springs 22 can be varied to match the desired spacing between the rear side 54 and the developing cartridge 12 as well as the desired pressing force of the developer roller 20 against the photosensitive drum 16.

It should be appreciated by the person skilled in the art that the invention is not limited to the embodiment described. In particular, the following modifications and improvements may be made without departing from the scope of the present invention:
The urging springs may be recessed into the cartridge and actuated by projections.
The urging springs 22 may take the form of leaf springs, with appropriate modifications being made to the positions of the mounting pins and screw recess,
The simple locking mechanism may be omitted.

It should be further appreciated by the person skilled in the art that the features described in one embodiment, where not mutually exclusive or alternatives, may be combined with features described in other embodiments to create yet further embodiments that fall within the scope of the present invention.

1. A resiliently biased developing cartridge adapted to be received within a drum cartridge having a photosensitive drum and a rear wall, the resiliency biased developing cartridge having at least one resilient means and a developer roller, such that, when the developing cartridge is received within the drum cartridge, the compression of the at least one resilient means against the rear wall of the drum cartridge results in the positioning of the developing cartridge such that a predetermined pressure is applied by the developer roller against the photosensitive drum.

2. A resiliently biased developing cartridge according to claim 1, where the at least one resilient means take the form of a torsion coil spring.

3. A resiliently biased developing cartridge according to claim 1, where the developing cartridge has a recess for each resilient means, each resilient means able to retract into the recess to facilitate the receipt of the developing cartridge within the drum cartridge.

4. A resiliently biased, developing cartridge according to claim 3, where the resilient means has a curved portion that guides the resilient means to the retracted position as the developing cartridge is received within the drum cartridge.

5. A resiliently biased developing cartridge according to claim 3, where the resilient means is biased towards a non-retracted position.

6. A resiliently biased developing cartridge according to claim 3, where the resilient means remain retracted in the recess until an actuating projection provided, in the drum cartridge makes contact with a predetermined portion of the developing cartridge.

7. A resiliently biased developing cartridge according to claim 1, the resiliently biased developing cartridge also including a locking mechanism for securely retaining the developing cartridge to the drum cartridge when the developing cartridge is received in the drum cartridge.

8. A resiliently biased developing cartridge according to claim 1, where the pressure applied by the resilient means against the rear wall is in the order of 7 N.

9. A resiliently biased developing cartridge according to claim 1, where the pressure applied by the developer roller against the photosensitive drum is between 10 N and 2ON.

10. (canceled)
